(19) United States
(12) Patent Application Publication
(10) Pub. No.: US 2005/0178414 A1
(43) Pub. Date: Aug. 18, 2005

(54) Dishwasher

(75) Inventor: Myung Ho Kang, Nam-go (KR)

Correspondence Address: FLESHNER & KIM, LLP, P.O. BOX 221200, CHANTILLY, VA, 20153, US

(73) Assignee: LG Electronics Inc.

(21) Appl. No.: 10/888,584

(22) Filed: Jul. 12, 2004

(30) Foreign Application Priority Data
Feb. 13, 2004 (KR) P2004-0009694

(51) Int. Cl. B08B 3/02

(52) U.S. Cl. 134/176; 134/179; 134/135; 134/200; 134/184

(57) ABSTRACT

A dishwasher is disclosed. The dishwasher includes a washing chamber capable of being opened and closed by a door, at least one rack provided in the washing chamber for placing dishes therein, a sump provided below the washing chamber for containing washing water, a pump for pumping the washing water from the sump, at least one spray arm provided within the washing chamber for sprinkling the washing water pumped by the pump, and a top sprinkler provided in an upper portion of the washing chamber for sprinkling the washing water pumped by the pump directly toward outmost areas of the washing chamber.

This application claims the benefit of Korean Application No. P2004-009694, filed on Feb. 13, 2004, which is hereby incorporated by reference.

### BACKGROUND OF THE INVENTION

1. Field of the Invention

The present invention relates to dishwashers, and more particularly, to a device for spraying washing water to dishes in a washing chamber.

2. Description of the Related Art

The dishwasher washes and dries dishes automatically, by spraying washing solution and washing water to the dishes. In general, the dishwasher is provided with at least one rack in the washing chamber for placing the dishes thereon, a sump for containing the washing water, at least one spray arm under the rack for spraying the washing water toward the dishes on the rack, and a pump for supplying the washing water from the sump to the spray arm.

In the operation, when the pump is put into operation, the dishes are washed as the spray arm sprays the washing water from the sump to the dishes. The washing water sprayed to the dishes returns to the sump again, and sprayed to the dishes again.

In case of the above-described typical dishwasher, there is a problem in that the dishes placed in an upper space of the washing chamber, more particularly, outmost areas thereof are not washed well. There is also a problem in that contaminated washing water having washed the dishes as the washing water is sprayed from a lower part to an upper part contaminates the dishes again as the contaminated washing water falls down.

Therefore, referring to FIG. 1, recently, in order to prevent this, a dishwasher is provided, which has a top spray arm 5 provided to a ceiling of the washing chamber 1, additionally. The top spray arm 5 has nozzles 5a at opposite ends for spraying the washing water toward upper outmost areas of the washing chamber 1, horizontally. For reference, in FIG. 1, reference symbol 2 denotes a rack, and reference symbol 7 denotes a washing water supply tube.

However, since the top spray arm 5 sprays the washing water horizontally, the dishwasher still has a problem in that dishes at the upper outmost areas of the washing chamber 1 are not washed properly. This is because the washing water sprayed from the top spray arm 5 moves on a straight line horizontally until the washing water hits the dishes near to the top spray arm 5, to fail to reach to the dishes placed thereafter. Consequently, as shown in FIG. 1, the dishwasher with the top spray arm 5 has wash flimsy areas ‘A’, as shown in FIG. 1.

In the meantime, for preventing re-contamination of the dishes by the contaminated washing water having washed the dishes and fallen down, it is important to supply more washing water than to supply the washing water at a high pressure. However, since the top spray arm 5, shown in FIG. 1, sprays the washing water to the dishes at the outmost areas of the washing water chamber 1 by using a high pressure, an efficiency of re-contamination prevention becomes deficient.

Moreover, for increasing a spray pressure of the top spray arm 5, it is required to increase a flow rate to the top spray arm 5, when it is required to reduce a flow rate of the washing water supplied to other spray arms (not shown), that drops washing performance of other spray arms.

In the meantime, the top spray arm 5 has an upper piece and a lower piece injection molded and bonded together. Therefore, in order to fabricate the top spray arm 5, not only injection molds but also an expensive bonding device are required. Accordingly, not only the fabrication is difficult, but also a production cost increases.

### SUMMARY OF THE INVENTION

Accordingly, the present invention is directed to a dishwasher that substantially obviates one or more of the problems due to limitations and disadvantages of the related art.

An object of the present invention is to provide a dishwasher, which can also wash dishes at upper outmost areas of an inside of a washing chamber, uniformly.

Another object of the present invention is to provide a dishwasher, which enables to save component production cost of a dishwasher.

Additional features and advantages of the invention will be set forth in the description which follows, and in part will be apparent to those having ordinary skill in the art upon examination of the following or may be learned from practice of the invention. The objectives and other advantages of the invention will be realized and attained by the structure particularly pointed out in the written description and claims hereof as well as the appended drawings.

To achieve these objects and other advantages and in accordance with the purpose of the present invention, as embodied and broadly described herein, a dishwasher includes a washing chamber capable of being opened and closed by a door, at least one rack provided in the washing chamber for placing dishes therein, a sump provided below the washing chamber for containing the washing water, a pump for pumping the washing water from the sump, at least one spray arm provided below the washing chamber for sprinkling the washing water pumped by the pump, and a top sprinkler provided in an upper portion of the washing chamber for sprinkling the washing water pumped by the pump directly toward outmost areas of the washing chamber.

The top sprinkler may be provided to a ceiling of the washing chamber, and the top sprinkler may include a head connected to a tube which guides the washing water pumped by the pump, the head discharging the pumped washing water, and an impeller rotatably coupled to the head for sprinkling the washing water discharged from the head.

The head includes an opening in communication with the tube, a shaft projected downward and coupled with the impeller, and at least one through hole for discharging the washing water supplied from the tube. The at least through hole is provided on a left side and a right side of the shaft, respectively, when seen from above.

The head further includes a guide provided to a bottom side surface of the head to surround the at least one through hole, for guiding the washing water discharged from the head toward the impeller without being scattered, and an aperture in which a projection provided on an outer surface of the tube is inserted to ensure a secure connection between the tube and the head.

The impeller includes a plate rotatably mounted to the head, the plate having a slope such that the discharged water is sprinkled upward, and a plurality of flow passages formed between a center and the edge of the plate for guiding the washing water discharged from the-head toward the edge of the plate. The impeller further includes a boss provided to the center of the plate, wherein the boss is rotatably mounted to the head. Herein, the plate has a parabolic section protruded downward between the center and an edge of the plate.

The flow passages are formed by a plurality of ribs provided on an upper surface of the plate. Each flow passage is formed by a pair of ribs provided on an upper surface of the plate. Herein, a distance between the pair of ribs decreases in a radial direction toward the edge of the plate.

The flow passages may be spaced at regular angular intervals around the center of the plate. Herein, at least one of the flow passages may be curved.

The head of the dishwasher further includes a through hole provided at a position spaced at a predetermined angle away in a direction opposite to a direction of the curve of the flow passage when seen from above, for discharging the washing water. The through hole has a size determined according to a desired spray range of the top sprinkle.

In another aspect of the present invention, a dishwasher includes a washing chamber capable of being opened and closed by a door, at least one rack provided in the washing chamber for placing dishes therein, a sump provided below the washing chamber for containing the washing water, a pump for pumping the washing water from the sump, a tube for guiding the washing water pumped by the pump to an inside of the washing chamber, and a sprinkler for sprinkling the washing water directly toward outmost areas of the washing chamber, wherein the sprinkler includes a head connected to the tube, the head having at least one through hole for discharging the washing water, and an impeller rotatably coupled to the head, the impeller having a plate sloped upward such that the discharged water is sprinkled upward and a plurality of ribs provided on an upper surface of the plate between a center and an edge of the plate.

It is to be understood that both the foregoing description and the following detailed description of the present invention are exemplary and explanatory and are intended to provide further explanation of the invention claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 illustrates a diagram showing a top spray arm at a ceiling of a washing chamber of a related art dishwasher, schematically;

FIG. 2 illustrates a diagram of a dishwasher in accordance with a preferred embodiment of the present invention, schematically;

FIG. 3 illustrates a top sprinkler of the dishwasher in FIG. 2, schematically;

FIG. 4 illustrates a disassembled perspective view of the top sprinkler of the dishwasher in FIG. 2;

FIG. 5 illustrates a section of the top sprinkler of the dishwasher in FIG. 2;

FIG. 6 illustrates a bottom view of the top sprinkler in FIG. 5 having an impeller removed therefrom;

FIG. 7 illustrates a plan view of an impeller of a top sprinkler in the dishwasher in FIG. 2; and

FIGS. 8 and 9 illustrate diagrams each showing a spray range versus a nozzle size in the top sprinkler in FIG. 5.

### DETAILED DESCRIPTION OF THE PREFERRED EMBODIMENT

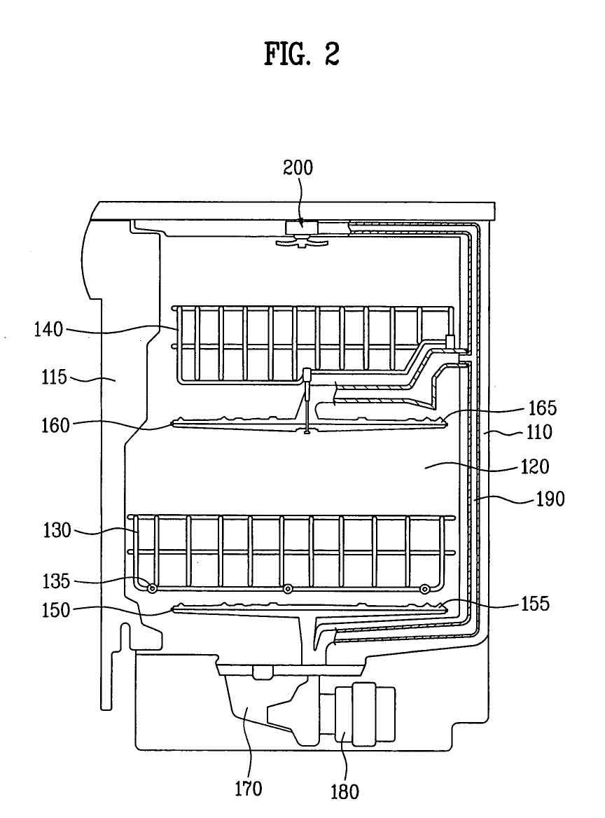

Reference will now be made in detail to the preferred embodiment of the present invention, examples of which are illustrated in the accompanying drawings. In describing the embodiment, identical parts will be given the same names and reference symbols, and repetitive description of which will be omitted. FIG. 2 illustrates a diagram of a dishwasher in accordance with a preferred embodiment of the present invention.

Referring to FIG. 2, there is a case 110 having a washing chamber 120 provided therein capable of being opened and closed by a door 115 provided to a front of the case 110. There is at least one rack in the washing chamber 120 for receiving dishes. FIG. 2 illustrates a diagram showing an example in which two racks (i.e., an upper rack 140 and a lower rack 130) are provided in the washing chamber 120.

The upper rack 140 and the lower rack 130 can be drawn out of the washing chamber 120 when the door 115 is opened. For this, the upper rack 130 is provided with a plurality of rollers 135, and the washing chamber 120 is provided with a rail (not shown) at a side wall thereof for supporting the upper rack 140, and guiding sliding of the upper rack 140.

There is a sump 170 provided below the washing chamber 120 for containing the washing water. The sump 170 contains clean water supplied from an outside of the dishwasher in water supply. For this, the sump 170 has a water supply pipe (not shown), and a water supply valve (not shown) for supplying clean water. Moreover, the sump 170 also receives contaminated washing water having washed the dishes in the washing chamber 120 and fallen down. There is a filtering device (not shown) connected to the sump 170, for filtering the contaminated washing water during washing.

Referring to FIG. 2, the sump 170 has a pump 180 connected thereto for pumping the washing water contained in the sump 170. The pump 180 includes a motor connected to one side of the sump 170, and an impeller provided in the sump 170 and coupled to the motor with a shaft. Therefore, upon putting the motor, the impeller rotates to pump the washing water from the sump 170.

In the meantime, there is at least one spray arm, for example, an upper arm 160 and a lower arm 150, is provided under the racks, for example, the upper rack 140 and the lower rack 130. The upper arm 160 and the lower arm 150 have nozzles 155 and 165 provided thereto for spraying the washing water, respectively. The upper arm 160 and the lower arm 150 are connected to a tube 190, which guides the washing water pumped from the sump 170 by the pump 180.

Accordingly, when the pump 180 is put into operation, the washing water is supplied from the sump 170 to the upper arm 160 and the lower arm 150 through the tube 190, respectively. The nozzles 155 and 165 spray the washing water toward the dishes on the upper rack 140 and the lower rack 130, respectively.

The upper arm 160 and the lower arm 150 are rotatably mounted, and the nozzles 155 and 165 are mounted to spray the washing water vertically or slantingly. Therefore, the upper arm 160 and the lower arm 150 rotate by reaction of slanted spray of the washing water from the nozzles 155 and 165, respectively. Accordingly, the washing water is sprayed to an inside of the washing chamber 120 uniformly by a centrifugal force of the rotation of the upper arm 160 and the lower arm 150.

In the meantime, referring to FIG. 2, there is a top sprinkler 200 on an upper part of an inside of the washing chamber 120, such as a ceiling of the washing chamber 120. The top sprinkler 200 sprays the washing water pumped by the pump 180 so as to proceed to the outmost areas of the washing chamber 120.

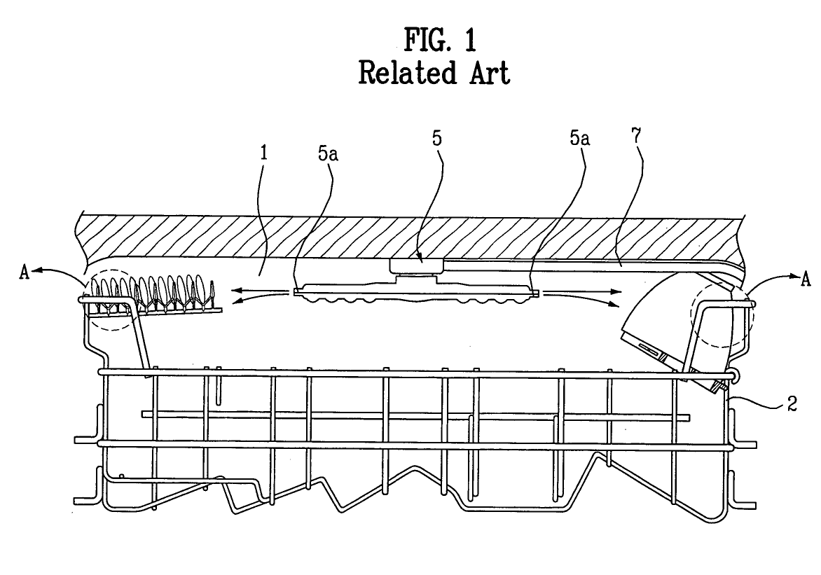

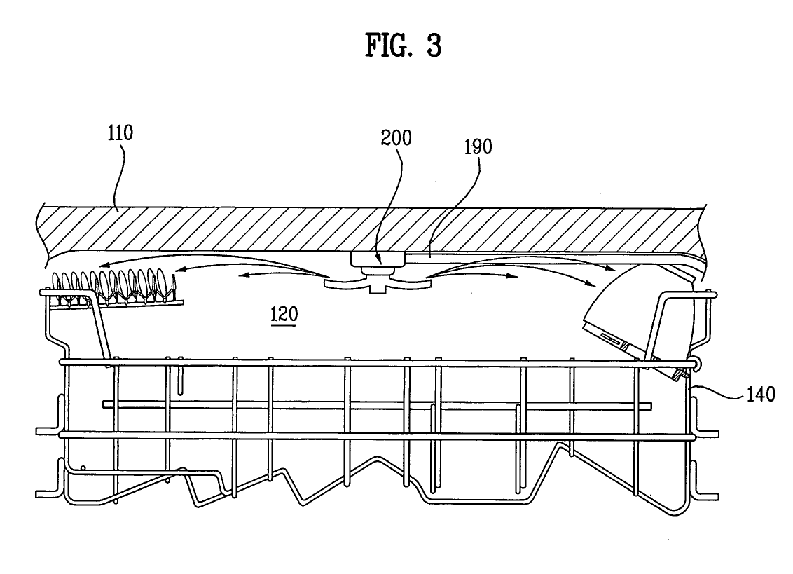

Referring to FIG. 3, if the washing water is sprayed so as to be projected upward, a portion of the washing water washes dishes near to the top sprinkler 200 and another portion of the washing water goes over the dishes and washes the dishes at the edges of the upper rack 140, thereby eliminating the washing flimsy areas ‘A’ (shown in FIG. 1) in the related art. Moreover, the washing water sprayed from the top sprinkler 200 even prevents the dishes from being re-contaminated with the contaminated washing water having washed the dishes, and fallen down thereto. The top sprinkler 200 will be described in more detail with reference to FIGS. 3 to 9.

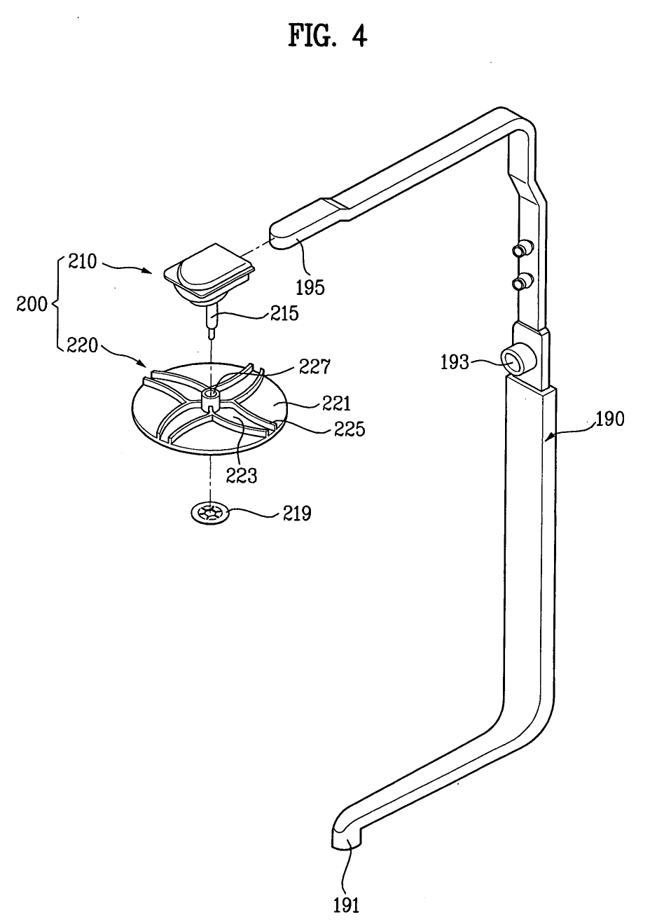

Referring to FIGS. 3 to 5, the top sprinkler 200 is connected to the tube 190 for guiding the washing water pumped by the pump 180. The tube 190 has one inlet 191 and at least one outlet, wherein the inlet 191 is in communication with the pump 180, and the outlet is in communication with the spray arm and the top sprinkler 200. For reference, in FIG. 4, the first outlet 193 is connected to the upper arm 160, and the second outlet 195 is connected to the top sprinkler 200. Of course, though not shown, the tube 190 has an outlet connected to the lower arm 150. Meanwhile, a part of the tube 190 may be buried in the case 110, as shown in FIG. 2.

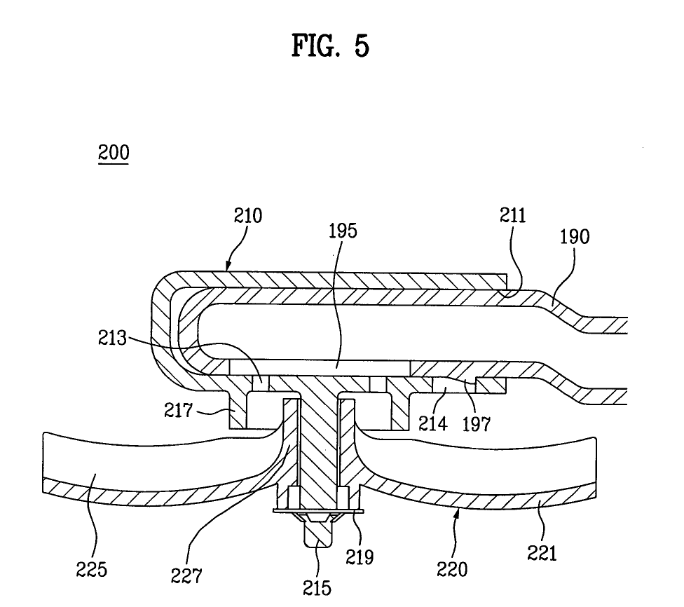

Referring to FIGS. 4 and 5, the top sprinkler 200 connected to the tube 190 includes a head 210 and an impeller 220. The head 210 is connected to the tube 190 for spraying (or discharging) the washing water, and the impeller 220 is rotatably coupled to the head 210 with a shaft for sprinkling the washing water such that the washing water is projected to the outmost areas of the washing chamber 120, which will be described in detail.

Referring to FIG. 5, a part of the head 210 may be buried in the ceiling of the case 110. The head 210 has a space therein, and an opening 211 in one side for enabling communication between the space and an outside of the head 210. One end of the tube 190 having the second outlet 195 formed therein is inserted in the head 210 through the opening 211.

The head 210 has at least one through hole 213. For example, two through holes 213 are in a lower surface of the head 210, and, as shown in FIG. 5, become in communication with the second outlet 195 when the head 210 is joined with the tube 190. The washing water introduced into the head 210 through the tube 190 is sprayed through the through holes 213.

Referring to FIGS. 4 and 5, the head 210 has a shaft 215 projected from an under side. The shaft 215 has the impeller 220 coupled thereto. The shaft 215 has a snap ring 219 at a lower end for preventing the impeller 220 rotatably coupled to the shaft 215 from breaking away from the shaft 215.

The tube 190 and the head 210 may have a projection 197 and an aperture 214 provided thereto, respectively. As shown in FIG. 5, the projection 197 is projected from an outer surface of the tube 190, and the aperture 214 receives the projection 197 when the head 210 is joined with the tube 190, thereby preventing the head 210 from breaking away from the tube 190 by water pressure or a vibration.

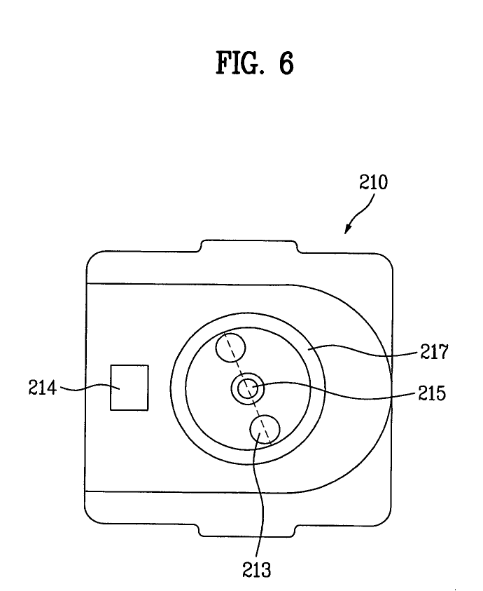

Moreover, there may be a guide 217 for guiding the washing water from the through hole 213 to the impeller 220. As shown in FIG. 6, the guide 217 surrounds the through holes 213 and the shaft 215 for guiding the washing water from the through holes 213 of the head 210 to an upper central part of the impeller 220 without being scattered.

In the meantime, the impeller 220 is rotatably mounted to a lower part of the head 210 (i.e., to the shaft 215). The impeller 220 has a plate 221 for rotating and sprinkling the washing water, and flow passages 223 on the plate 221 for fixing a direction of spray of the washing water.

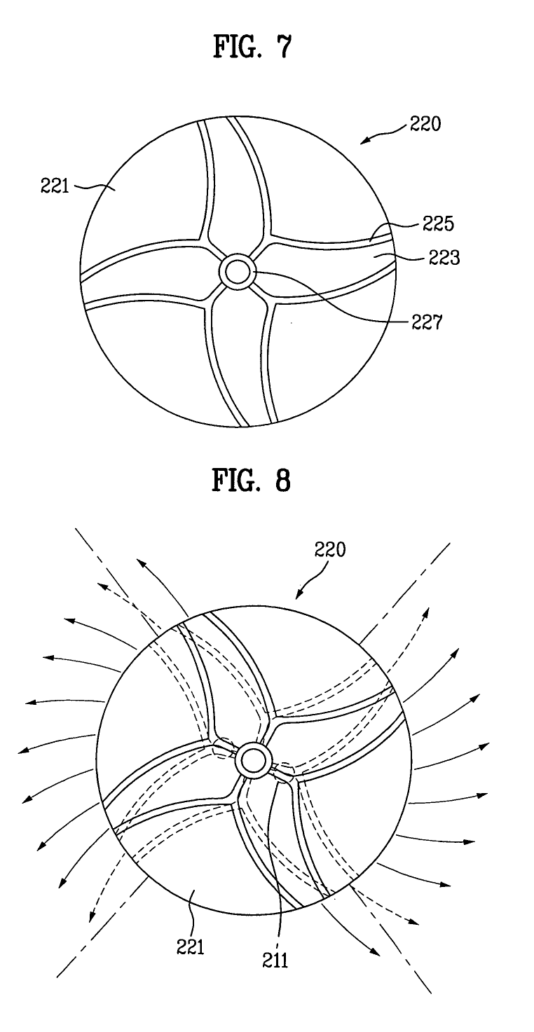

Referring to FIGS. 4 and 7, the plate 221 is circular, and has the shaft 215 rotatably coupled at a center. The plate 221 receives and rotates the washing water from the through holes 213 of the head 210, to sprinkle to outmost areas inside of the washing chamber 120.

Referring to FIG. 5, the plate 221 may have a boss 227 at a center. The boss 227 enables stable rotation of the plate 221 around the shaft 215. The plate 221 is sloped such that an edge of the plate 221 is directed upward, slightly. This structure enables the plate 221 to apply force to the washing water having arrived to the plate 221 and being sprayed in a radial direction of the plate 221, not only in a horizontal direction, but also in a vertical direction. Accordingly, as shown in FIG. 3, the washing water sprayed from an edge of the plate 221 is made to proceed to the outmost areas of the washing chamber 120 while being projected upward.

Moreover, referring to FIG. 5, a middle of the plate 221, for example, a section between the boss 227 and the edge of the plate 221 has a parabola protruded downward. This structure enables the washing water having sprayed from the through holes 213 of the head 210, and hit a part adjacent to the boss 227 of the plate 221 to flow smoothly toward the edge of the plate 221 without much splashing.

In the meantime, a proceeding direction of the washing water having arrived to the plate 221 and being sprayed from the edge of the plate 221 is fixed guided by the flow passages 223. For this, as shown in FIGS. 4 and 7, the flow passages are provided in the middle of the plate 221, for example, between the boss 227 and the edge of the plate 221.

Referring to FIGS. 4 and 7, the flow passages are formed of a plurality of ribs 225 projected from an upper surface of the plate 221, in more detail, provided along a radial direction of the plate 221 in the middle of the plate 221, for example, between the boss 227 and the edge of the plate 221.

Moreover, referring to FIGS. 4 and 7, the flow passage 223 may be formed of one pair of ribs 225 spaced apart from each other (i.e., two adjacent ribs 225). Then, the flow passage 223 can effectively guide the washing water sprayed from the through holes 213.

Once the flow passages 223 are provided to the plate 221, the washing water sprayed from the through holes 213 and reached to the middle part of the plate 221 proceeds along the flow passages 223, and is sprayed from the edge of the plate 221 toward the outmost areas in the inside of the washing chamber 120. According to this, positions of spray of the washing water vary in accordance with positions and forms of the flow passage 223.

Referring to FIGS. 4 and 7, the flow passages 223 for guiding the washing water and fixing a spray direction of the washing water are at regular angular intervals to each other around the center of the plate 221, for example, the boss 227. That is, the one pair of ribs 225 that form the flow passage 223 are spaced away from other one pair of ribs 225 at a predetermined angular interval around the boss 227. Then, the washing water can be sprayed to a particular area, uniformly.

In the meantime, it is required that the washing water sprayed from the edge of the plate 221 can reach to the outmost areas of the washing chamber 120. For this, it is required to increase a pressure of the washing water sprayed from the plate 221.

To do this, the flow passage 223 is formed to be smaller as it goes farther toward the edge of the plate. That is, a distance of adjacent ribs 225 becomes smaller as it nears the edge of the plate 221. Then, a pressure of the washing water having guided by the flow passage 223 and being sprayed from the plate 221 increases enough to reach to the outmost areas of the washing chamber 120.

Referring to FIGS. 4 and 7, the flow passage 223 may be curved. In this instance, the flow passage 223 is substantially spiral in clock or anti-clockwise direction when the plate 221 is seen from above. This structure of the flow passage 223 enables an easy rotation of the impeller 220 by the water pressure of the washing water sprayed from the through holes 213, and spray of the washing water to a predetermined area as the impeller 220 rotates.

In the meantime, it is favorable that a large amount of washing water is sprayed from the top sprinkler 200 to a space having many dishes placed therein. For this, as shown in FIG. 6, two through holes 213 are provided to a left region and a right region of the shaft 215 when the head 210 is seen from above. The two through holes 213 are symmetrical with respect to the shaft 215. Above positions of through holes 213 enables to spray the washing water, not in a front direction, but in a left side and a right side of the washing chamber 120 where many dishes are placed therein.

Along with this, the two through holes 213 are arranged at positions spaced an angle away in a direction opposite to the direction of curve of the flow passage 223 when seen from above or below. For example, as shown in FIG. 6, the through hole 213 is formed at a position spaced at an angle away in a direction opposite to the direction of spiral of the flow passage 223 and the rib 225 around a vertical line passing through the shaft 215 when seen from above or below. Then, deviation of the washing water sprayed along the spiral flow passage 223 can be compensated. The deviation direction and angle of the through hole 213 is fixed according to a position of the through hole 213, and forms of the flow passages 223 and the ribs 225.

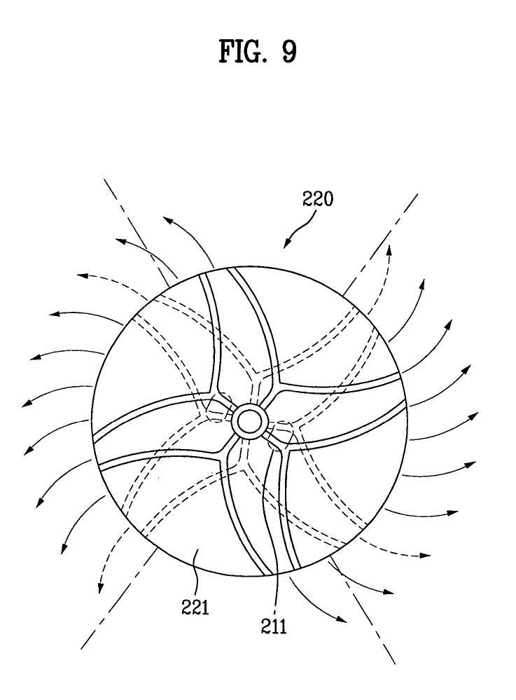

Moreover, a spray rate and a spray range of the washing water by the impeller 220 vary with the size and form of the through holes 213. That is, a size change of the through hole 213 changes the spray rate of the washing water of the top sprinkler 200, and, as shown in FIGS. 8 and 9, a length change of the through hole 213 changes the spray range of the washing water. Thus, the easy change of the spray rate and the spray range of the washing water enable an easy application of the top sprinkler 200 to the dishwashers with a variety of capacities.

In the meantime, in the operation of the dishwasher, when the pump 180 is put into operation in the washing or rinsing, the washing water is supplied from the sump 170 to the upper arm 160, the lower arm 150, and the top sprinkler 200 through the tube 190. In this instance, the washing water supplied to the upper arm 160 and the lower arm 150 is sprayed upward through the nozzles 155 and 165, so as to wash the dishes on the upper rack 140 and the lower rack 130.

The washing water supplied to the top sprinkler 200 gushes downward through the second outlet 195 of the tube 190 and the through holes 213 in the head 210. In this instance, the guide 217 guides the washing water to be supplied to the impeller 220 without being splashed. The washing water reached to the upper surface of the impeller 220, moves toward the edge of the plate 221 along the flow passage 223.

In this instance, since the washing water moving at a high pressure hits the curved, more specifically, spiral ribs 225, the impeller 220 rotates. The washing water guided by the flow passage 223 is sprayed upward from the edge of the plate 221 at a predetermined angle. In this instance, as a width of the flow passage 223 becomes smaller, the flow speed of the washing water becomes faster, to improve a spraying force of the washing water, to enable to reach to the left and right peripheries of the upper rack 140 depending on positions of the through holes 213 and ribs 225.

Referring to FIG. 3, the washing water sprayed from the impeller 220 proceeds toward the edges of the washing chamber 120. In this instance, a portion of the washing water washes dishes near to the top sprinkler 200, and the other portion of the washing water reaches a littler farther, and washes dishes at the outmost areas of the rack 140. Thus, the wash flimsy area (‘A’ in FIG. 1) in the related art is eliminated.

In the meantime, the washing water gushed downward from the through hole 213 may be sprayed into the washing chamber 120 through a space between the flow passages 223. In this case, since the water pressure is low, the washing water cannot reach far, but falls down in a neighboring area. Therefore, as shown in FIG. 3, the top sprinkler 200 of the present invention can spray the washing water over a large area in an upper portion of the washing chamber 120. Therefore, the washing water sprayed from the top sprinkler 200 can wash the contaminants sprayed by the washing water sprayed from the upper arm 160 and the lower arm 150.

Moreover, the top sprinkler 200 requires a spray pressure not higher than a related art top spray arm. Therefore, the flow rate of the washing water supplied to other spray arms (i.e., the upper arm 160 and the lower arm 150) through the tube 190 increases higher than the related art, to increase a spray pressure of the upper arm 160 and the lower arm 150 and to improve a washing performance.

As described above, the dishwasher of the present invention has the following advantage.

Firstly, the spraying of the washing water to reach to outmost areas of the washing chamber with the top sprinkler enables to eliminate the washing flimsy area, to uniformly wash the dishes in the washing chamber.

Secondly, since the top sprinkler requires no high spray force, the dish of the present invention can supply a higher flow rate of washing water to other spray arms, to increase a spray pressure of the washing water of the other spray arms. Accordingly, a washing performance of the dishwasher is improved.

Thirdly, the top sprinkler has a very simple structure and is fabricated by assembling the head and the impeller formed separately. Therefore, not only the fabrication and assembly easy, but also a production cost is saved.

Finally, by changing size and form of the through hole in the head of the top sprinkler, flow rate and spraying range of the washing water sprayed from the top sprinkler can be adjusted. Accordingly, the top sprinkler is applicable to dishwashers with different capacities.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A dishwasher comprising:
a washing chamber capable of being opened and closed by a door;
at least one rack provided in the washing chamber for placing dishes therein;
a sump provided below the washing chamber for containing washing water;
a pump for pumping the washing water from the sump;
at least one spray arm provided below the washing chamber for sprinkling the washing water pumped by the pump; and
a top sprinkler provided in an upper portion of the washing chamber for sprinkling the washing water pumped by the pump directly toward outmost areas of the washing chamber.

2. The dishwasher as claimed in claim 1, wherein the top sprinkling is provided to a ceiling of the washing chamber.

3. The dishwasher as claimed in claim 1, wherein the top sprinkling comprises:
a head connected to a tube which guides the washing water pumped by the pump, the head discharging the pumped washing water; and
an impeller rotatably coupled to the head for sprinkling the washing water discharged from the head.

4. The dishwasher as claimed in claim 3, wherein the head comprises:
an opening in communication with the tube;
a shaft projected downward and coupled with the impeller; and
at least one through hole for discharging the washing water supplied from the tube.

5. The dishwasher as claimed in claim 4, wherein the at least one through hole is provided on a left side and a right side of the shaft, respectively, when seen from above.

6. The dishwasher as claimed in claim 4, wherein the head further comprises a guide provided to a bottom side of the head to surround the at least one through hole, for guiding the washing water discharged from the head toward the impeller without being scattered.

7. The dishwasher as claimed in claim 4, wherein the head further comprises an aperture in which a projection provided on an outer surface of the tube is inserted to ensure a secure connection between the tube and the head.

8. The dishwasher as claimed in claim 3, wherein the impeller comprises:
a plate rotatably mounted to the head, the plate having a slope such that the discharged water is sprinkled upward; and
a plurality of flow passages formed between a center and the edge of the plate for guiding the washing water discharged from the head toward the edge of the plate.

9. The dishwasher as claimed in claim 8, wherein the impeller further comprises a boss provided to the center of the plate, wherein the boss is rotatably mounted on the head.

10. The dishwasher as claimed in claim 8, wherein the plate has a parabolic section protruded downward between the center and an edge of the plate.

11. The dishwasher as claimed in claim 8, wherein the flow passages are formed by a plurality of ribs provided on an upper surface of the plate.

12. The dishwasher as claimed in claim 8, wherein each flow passage is formed by a pair of ribs provided on an upper surface of the plate.

13. The dishwasher as claimed in claim 12, wherein a distance between the pair of ribs decreases in a radial direction toward the edge of the plate.

14. The dishwasher as claimed in claim 8, wherein a width of each flow passage decreases in a radial direction toward the edge of the plate.

15. The dishwasher as claimed in claim 8, wherein the flow passages are spaced at regular angular intervals around the center of the plate.

16. The dishwasher as claimed in claim 8, wherein at least one of the flow passages is curved.

17. The dishwasher as claimed in claim 16, wherein the head further includes a through hole provided at a position spaced at a predetermined angle away in a direction opposite to a direction of curve of the flow passage when seen from above, for discharging the washing water.

18. The dishwasher as claimed in claim 17, wherein the through hole has a size determined according to a desired spray range of the top sprinkler.

19. A dishwasher comprising:
a washing chamber capable of being opened and closed by a door;
at least one rack provided in the washing chamber for placing dishes therein;
a sump provided below the washing chamber for containing the washing water;
a pump for pumping the washing water from the sump;
a tube for guiding the washing water pumped by the pump to an inside of the washing chamber; and
a sprinkler for sprinkling the washing water directly toward outmost areas of the washing chamber, wherein the sprinkler comprises:
a head connected to the tube, the head having at least one through hole for discharging the washing water; and
an impeller rotatably coupled to the head, the impeller having a plate sloped upward such that the discharged water is sprinkled upward and a plurality of ribs provided on an upper surface of the plate between a center and an edge of the plate.

20. The dishwasher as claimed in claim 19, wherein the at least one through hole is provided on a left region and a right region of a center of the plate when seen from above, respectively.

21. The dishwasher as claimed in claim 19, wherein the plate has a parabolic section protruded downward between the center and an edge of the plate.

22. The dishwasher as claimed in claim 19, wherein the plurality of ribs comprises at least one pair of ribs forming a water flow passage that guides the washing water discharged from the head.

23. The dishwasher as claimed in claim 22, wherein the at least one pair of ribs is arranged such that a width of the water flow passage decreases in a radial direction toward the edge of the plate.

24. The dishwasher as claimed in claim 19, wherein the plurality of ribs is curved.

25. The dishwasher as claimed in claim 19, wherein the through hole is provided at a position spaced at a predetermined angle away in a direction opposite to a direction of curve of the flow passage when seen from above, for spraying the washing water.

26. The dishwasher as claimed in claim 25, wherein the through hole has a size determined according to a desired spray range of the top sprinkler.
